(19) United States
(12) Patent Application Publication
(10) Pub. No.: US 2002/0139844 A1
(43) Pub. Date: Oct. 3, 2002

(54) Method for enabling credit cards and device therefor

(76) Inventors: Tzur Rochman, Rishon Lezion (IL); Eitan Rochman, Rishon Lezion (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/154,966

(22) Filed: May 28, 2002

Related U.S. Application Data
(63) Continuation of application No. 09/819,677, filed on Mar. 29, 2001, now abandoned.

(51) Int. Cl. G06K 5/00

(52) U.S. Cl. 235/380

(57) ABSTRACT

A device for information storage and retrieval. A card containing electromagnetic information, such as a credit card, an access card or security card is biased to be initially in an inactive state. The card can be activated only using a holding apparatus, and then only for a predetermined number of uses, after which the card becomes inactivated again. The holding apparatus includes a communication device for communicating to a remote location such as a credit company and acts as a mobile telephone. The holding apparatus also enables loading and altering all of the information on the card. Further, a method for determining if a transaction is allowed is described. Two security code lists are maintained, one list in a holding apparatus and one list at the remote location where the determination occurs. A security code is transferred to the card by the holding apparatus. When a transaction is to be allowed, the security code is transferred from the card to the remote location and compared to a corresponding security code at the remote location. If a predetermined relationship exists between the two codes, the transaction is allowed.

This is a continuation in part of U.S. patent application Ser. No. 09/819,677 filed on Mar. 29, 2001.

### FIELD AND BACKGROUND OF THE INVENTION

The present invention relates to a method for confirming transactions, specifically financial transactions such as performed using credit cards and the like as well as a device for enabling credit cards and the like, which enables protection of the information stored on the credit card.

Plastic cards having electronically stored data are widely used to perform a large variety of tasks, from being used as conventional credit or bankcards, to use as security keys or to operate door locks. Other types of cards are gas cards, building, room and/or elevator security access cards, personnel cards, Automated Teller Machine (ATM) cards, debit cards and cash cards. For purposes of this application, however, these cards will be generically referenced as “cards.”

Authorization cards are generally either magnetic, electronic “smart cards,” or passive electronic cards. A “smart card” is a card for storing electronic information with a built-in microprocessor and memory used for identification or financial transactions. When inserted into a reader, a smart card transfers data to and from a central computer. A smart card is more secure than a magnetic stripe card and can be programmed to self-destruct if the wrong password is entered too many times. As a financial transaction card, a smart card can be loaded with digital money and used like a travelers check, except that variable amounts of money can be spent until the balance is zero. For magnetic cards, information particular to the rightful card owner, i.e. confidential information, is typically stored in a magnetic strip located on the backside of the card. In order to complete a given transaction, the confidential information stored on the card is directly transmitted from the magnetic strip to a card reader for recognition and authorization. With regard to smart cards and passive electronic cards, the confidential information is stored electronically and is transmitted to a card reader. Though smart cards contain a power supply, passive electronic cards do not.

However, confidential information, such as credit card number, expiration date, Personal Identification Number (PIN) and name of card owner, may inadvertently become available to other parties. Fraudulent and unauthorized use of authorization cards has cost card users and issuers (such as VISA, Mastercard, American Express, and Diner's Club), as well as entities that accept credit cards as a form of payment for goods and services, a great deal of money.

There exist many patents that deal with the prevention of card fraudulence. U.S. Pat. No. 3,972,138 to Armbruster teaches a credit card which includes slots with magnetizable signal carrying tabs which

U.S. Pat. No. 6,095,416 to Grant et al. teaches a security feature in which an authorization card generally has two operational states, a disabled state and an enabled state. In the disabled state, which is the default mode of operation, access to confidential information stored on the card is denied. The card remains in the disabled state until a PIN code is entered on a keypad provided on the card. Once the card is enabled, access to the confidential information is permitted for a predetermined period of time, after which the card reverts back to the default disabled state. The security feature is implemented on a magnetic card, an electronic smart card, and passive electronic card. This patent however provides some time-dependant protection for an individual card and does not allow the card user any freedom of choosing a PIN code.

U.S. Pat. No. 5,585,787 to Wallerstein describes a single card that can be used to access several accounts belonging to the card owner saving the owner the need to carry several cards, one for each account. A keyboard present on the card permits access to the individual account by using varying identification numbers entered on the keyboard.

Several prior art patents deal with holders for credit cards in an attempt to provide the cards with both physical and electronic protection.

U.S. Pat. No. 4,942,831 to Tel teaches a device for the protective storage of objects. The device has a storage space, damaging means for rendering the objects useless and means for feeding in from the outside a command, which disables the damaging means.

U.S. Pat. No. 5,598,792 to Wales describes a credit card security device which prevents credit card and bank card fraud. The device includes a case with an access door secured by a lock for storing the cards and a detection member within the case for determining an entry into the case when the door is locked. The detection member operates an electromagnet within the case upon the entry. The electromagnet scrambles the code within each credit card's magnetic strip and thereby invalidates the credit cards for future use. The detection member comprises a normally open electrical circuit when the door is closed and locked and includes switches for providing a current flow to the invalidating electromagnet upon the entry. At least one such switch is a normally open pressure switch mounted in wall of the case that closes when the entry to the case is through the wall, thereby providing the current flow to the electromagnet. Another switch is associated with the lock and is open when the lock is unlocked, thereby precluding a current flow through the circuit, and which closes if the door is forcibly opened while locked, thereby providing the current flow to the electromagnet. An electromagnetic invalidation system that scrambles the code within each card's magnetic strip upon unauthorized opening of the case and thus, renders the cards useless. The disability of the card is irreversible.

A simpler way of disabling cards stored by a holder is described in U.S. Pat. No. 5,918,554 to Rassamni. This patent describes a credit card holder, which when opened in an unauthorized manner, releases ink that marks the hand of the opener and also permanently marks, hence disables, the credit cards held within.

None of the hereinabove mentioned patents sufficiently protect cards against fraud nor do they have reversible capabilities of disabling information.

There is thus a widely recognized need for a card-holding device devoid of the above limitations.

### SUMMARY OF THE INVENTION

According to one aspect of the present invention there is provided an information storage and retrieval system, the system including at least one card for electromagnetic storage of information, a holding apparatus having an opening for insertion thereto of the card and removal therefrom of the at least one card and a mechanism for reversibly disabling the at least one card for storing information, wherein then holding apparatus is functional as a mobile telephone such as a cellular telephone.

According to further features in preferred embodiments of the invention described below, the at least one card is selected from the group consisting of credit cards, bank cards, gas cards, security key cards, medical and personal record cards, building access cards, room access cards, elevator access cards, security access cards, personnel cards, Automatic Teller Machine cards, debit cards, key substitute cards, telephone cards and cash cards.

According to still further features in the described preferred embodiments, the at least one card is selected from the group consisting of magnetic cards, electronic smart cards and passive electronic cards.

According to still further features in the described preferred embodiments, the at least one card is initially biased to be in a disabled mode.

According to still further features in the described preferred embodiments, the at least one card is inserted in the opening, the holding apparatus holds at least part of the one card and is in at least partial contact with a portion of the one card where the information is stored.

According to still further features in the described preferred embodiments, wherein the mechanism for enabling the at least one card includes a keyboard.

According to still further features in the described preferred embodiments, wherein the mechanism for enabling the at least one card includes a mechanism for entering an identification code.

According to still further features in the described preferred embodiments, wherein the at least one card is operative to be enabled only via the holding apparatus.

According to still further features in the described preferred embodiments, the holding apparatus, being functional as a telephone, is configured to retrieve the information from the at least one card and communicating the information to a remote location.

According to still further features in the described preferred embodiments, the holding apparatus includes a mechanism for loading the information stored on the at least one card.

According to still further features in the described preferred embodiments, the holding apparatus includes a mechanism for altering the information stored on the at least one card.

According to still further features in the described preferred embodiments, the system further including a range detection mechanism. The mechanism includes a range detection mechanism, a mechanism for locating the tag within a predetermined range, operationally associated with the holding apparatus and an alerting mechanism if the card is not detected within the predetermined range.

There is also provided according to the teachings of the present invention a method for determining if a transaction (such as a credit card transaction) is allowed by:

a. providing a first ordered security code list stored in a first device (e.g. a holder of the present invention);

b. providing a second ordered security code list stored in a second device (e.g. a computer of a credit card company);

c. copying a first specific security code from the first ordered security code list to a third device (e.g. a smart card or credit card);

d. transferring a first specific security code to a confirmation location (e.g. the credit card company);

e. transferring a second specific security code from the second ordered security code list to the confirmation location;

f. comparing the first specific security code (from the holder via the card) and the second specific security code (from the credit card company) for a predetermined relationship;

g. if, subsequent to f, the predetermined relationship exists then the transaction is allowed; and

h. if, subsequent to f, the predetermined relationship does not exist, the transaction is not allowed.

According to a feature of the present invention the sought predetermined relationship is equality between the first specific security code and the second specific security code. According to a further feature of the present invention, the first and second list are substantially identical.

According to a feature of the present invention, the third device is selected from a group consisting of credit cards, bank cards, gas cards, security key cards, medical and personal record cards, building access cards, room access cards, elevator access cards, security access cards, personnel cards, Automatic Teller Machine cards, debit cards, key substitute cards, telephone cards and cash cards.

According to a feature of the present invention, copying of the first specific security code from the first ordered security code list to the third device is contingent on entering an identification code on a keyboard of the first device.

According to a feature of the present invention, the first device is functional as a mobile telephone.

According to another aspect of the present invention there is provided a method for storing information, the method including the steps of providing a card whereon the information is stored providing a holding apparatus, having an opening for insertion thereto of the card and removal therefrom of the card and configuring the card so that the card can be enabled only via the holding apparatus.

According to yet another aspect of the present invention there is provided a method for payment of a purchase by a purchaser to a vendor using a credit card, the method including the steps of establishing by the purchaser an account with a credit entity company, storing information by the credit entity company about the account on the credit card, providing by the purchaser a holding apparatus for the credit card capable of communicating with the credit entity company and debiting purchaser's account by the credit entity company the at least one account for the purchase.

According to still further features in the described preferred embodiments, the method further includes the step of enabling the card, using the holding apparatus.

According to still further features in the described preferred embodiments, the enabling is for a predetermined number of uses.

According to still further features in the described preferred embodiments, the enabling is effected by steps including entering an identification code on a keyboard of the holding apparatus.

According to still further features in the described preferred embodiments, the method further including the step of disabling the card after a predetermined number of uses.

According to still further features in the described preferred embodiments, the method for payment of a purchase by a purchaser to a vendor using a credit card further includes the steps of informing the vendor of the debiting of the account, by the at least one credit entity company and provision of the purchase by the vendor to the purchaser.

According to yet another aspect of the present invention there is provided a method for payment of a purchase by a purchaser to a vendor using a credit card, the method including the steps of establishing by the purchaser an account with a credit entity company, storing information by the credit entity company about the account on the credit card, providing by the purchaser a holding apparatus for the credit card capable of communicating with the credit entity company and debiting purchaser's account by the credit entity company the at least one account for the purchase.

According to still further features in the described preferred embodiments, the method for payment of a purchase by a purchaser to a vendor using a credit card further includes the steps of informing the vendor of the debiting of the account, by the at least one credit entity company and provision of the purchase by the vendor to the purchaser.

The present invention successfully addresses the shortcomings of the presently known configurations by providing a to a system and method for information storage and retrieval and, more particularly, to a credit card holder, which enables protection of the information stored on the credit card.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of a holding apparatus for at least one card for storing information;

FIG. 2 is a schematic representation of another embodiment of a holding apparatus for at least one card for storing;

FIG. 3 is a flow chart of a method for storing and retrieving information; and

FIG. 4 is a flow chart of a method of the present invention whereby transactions, such as credit card transactions, are allowed.

### DESCRIPTION OF THE PREFERRED EMBODIMENTS

The present invention is of a device and method for information storage and retrieval, which can be used to enable and disable cards for storing information.

Specifically, the present invention can be used to enable and disable a large variety of cards in addition to providing the cards for storing information with additional protection against fraud.

For purposes of this specification and the accompanying claims, the term “at least one card” generally refers to credit cards and includes, but is not limited to, bank cards, gas cards, security key cards, medical and personal record cards, building access cards, room access cards, elevator access cards, security access cards, personnel cards, Automatic Teller Machine cards, debit cards, key substitute cards, telephone cards and cash cards.

For purposes of this specification and the accompanying claims, the term “electromagnetic storage” refers to either of or both electronic and magnetic information stored.

For purposes of this specification and the accompanying claims, the term “at least one card for storing electromagnetic information” refers to, but is not limited to, magnetic cards, electronic smart cards, and passive electronic cards.

For purposes of this specification and the accompanying claims, the term “communication device” generally refers to modems and includes, but is not limited to, a standard telephone, a cordless telephone, a cellular telephone, a personal digital assistant and a computer with on-line capabilities.

The principles and operation of a system and method for information storage and retrieval according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

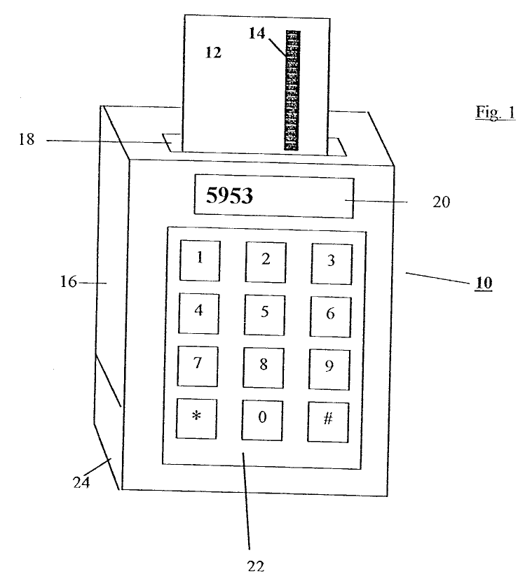

Referring now to the drawings, FIG. 1 illustrates a system 10 for storage and retrieval of information. System 10 includes at least one card 12 for storing information. The card illustrated in this embodiment is typically a credit card bearing a magnetic strip 14, which contains information concerning the bearer's account. Card 12 is operationally associated with a holding apparatus 16 having an opening 18 for insertion thereto of card 12 and removal therefrom of card 12. An AC or a DC source (not shown) powers holding apparatus 16.

Holding apparatus 16 contains a mechanism for reversibly enabling the card for storing information. In this preferred embodiment the enabling and disabling is run by an electromagnetic circuitry familiar to those skilled in the art of electromagnetism. Such systems are common and appear in numerous locations such as hotel reception desks where guests are given a key-card that is magnetically loaded on the spot for the guest or at the bank where the bank clerk swipes a newly issued credit card to enable use of a newly issued credit card.

Card 12 is biased to be in a disabled mode. Card 12 is ordinarily in a disabled mode. Card 12 is enabled for use only after having been in physical contact with holding apparatus 16. Card 12 is inserted in opening 18, and is in at least partial contact with magnetic strip 14. In this embodiment, the mechanism for enabling card 12 includes a keyboard 22, and the method of using the mechanism includes the step of entering an identification code using keyboard 22. In a preferred embodiment, apparatus 16 includes a display 20 for verifying that the correct identification code has been entered; a typical identification code is shown displayed in display 20 in FIG. 1. The identification code is chosen by the card owner and is unknown to anyone else including the credit card company and is not at all identical in any way (unless chosen by the card owner) to the PIN number on the card.

According to one embodiment of this invention, apparatus 16 includes a communication device 24 such as a modem for communicating the information stored in magnetic strip 14 to a remote location such as a credit company. Communication device 24 enables holding apparatus's 16 capability of loading and altering information onto card 12, which can be delivered to a user with no information on the card. The present invention can be included as an integral part of any telephone especially a cellular telephone.

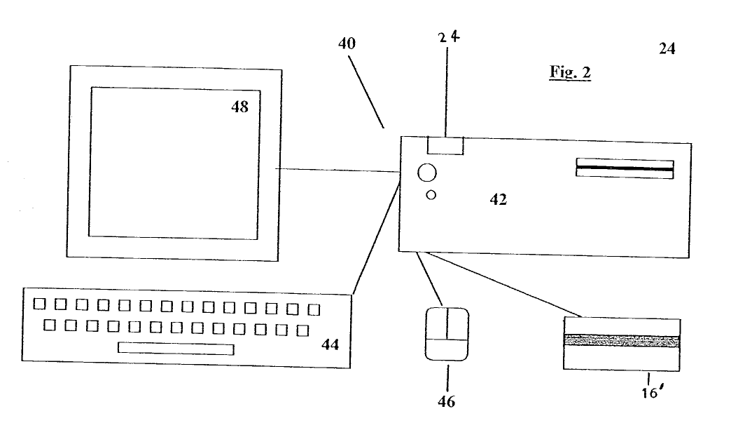

FIG. 2 illustrates another embodiment of system 10 for the storage and retrieval of information. This illustration shows holding apparatus 16 connected to a computer 40. Computer 40 includes a processor 42, a keyboard 44, a mouse 46, and a monitor 48. A holding apparatus 16′ that is permanently connected to a computer is similar in appearance to a bank teller's or a cash register's swipe extension for credit cards. Communication device 24 in this embodiment is within the computer itself.

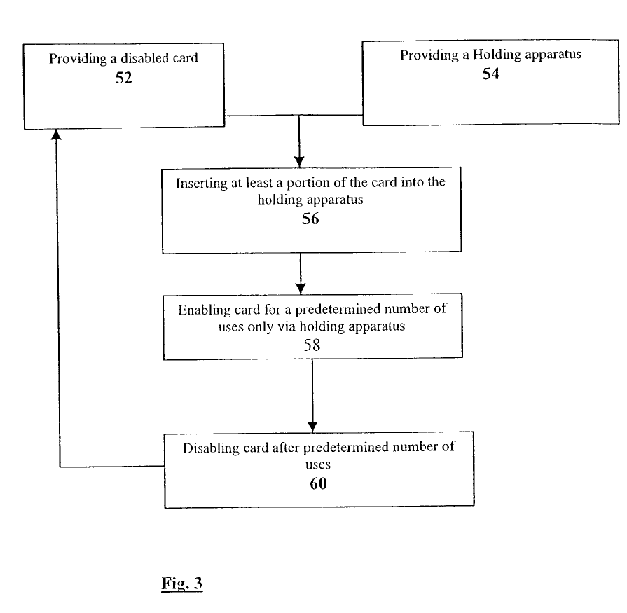

FIG. 3 is a flow chart showing a method for storing and retrieving information. A card such as card 12 is provided (block 52) and a holding apparatus such as apparatus 16 is provided (block 54). At least a portion of card 12 is inserted into holding apparatus 16 (block 56). Cards with built-in microprocessor and memory such as smart cards are enabled for a predetermined number of uses (block 58) by entering an identifying code using a keyboard 22 on holding apparatus 16, which sets a counter. Each time the smart card is used, the counter is decremented until the counter is reset, which disables the card 12 (block 60). Magnetic cards and passive electronic cards are enabled for a predetermined number of uses by holding apparatus 16 communicating, via communication device 24, to the authorization company such as VISA by instructing the authorization company to honor the card when swiped through a machine only for a predetermined number of uses. Card 12 is then enabled (block 52) for future uses only in conjunction with holding apparatus 16.. Smart cards can also be enabled in this manner, even though the previously mentioned method for enabling them is preferred.

In another embodiment of this invention a code, similar in nature to a Personal Identification Number (PIN) is entered via communication device 24 by the authorization center or by the card owner via keyboard 22, onto the card (magnetic cards, passive electronic cards and smart cards) which changes after the predetermined number of uses. This number must be recognized by the authorization center in order to allow transaction. In order to change the PIN on the card either by the card owner or by the credit card authorization company, the identification code must first be entered into holding apparatus 16. Holding apparatus 16 can be used to enable and disable numerous cards.

As a non-limiting example of method 50, a consumer wishes to make a purchase from a vendor either a service such as a meal in a restaurant or goods such as an appliance. The restaurant supplies the consumer with its supplier account number with the particular card that the consumer has (for example VISA, MasterCard or American Express). The supplier account number is entered by the consumer into holding apparatus 16 either manually via keyboard 22 or by beaming the supplier account number into holding apparatus 16 (much the same as in transfer of information between personal digital assistants by infra-red beaming). The consumer then enters the amount of money for this particular transaction. Holding apparatus 16 then contacts the credit card company via modem 24 and informs the credit card company of the transaction and the credit card company immediately informs the supplier or restaurant that the sale was authorized and the consumer will be charged for the service or goods received according to the consumer's credit terms. This seemingly longer process eliminates the necessity of the consumer having to reveal any of the consumer's credit card details including the number of the card, thus preventing any possibility of fraudulent or accidental use of the consumer's card or number.

In another embodiment of the present invention, holding apparatus also serves as a detection system for the card. Card 12 is tagged with a tag (not shown) responsive to a predetermined electromagnetic signal emitted from holding apparatus 16. When the card is within a predetermined range the mechanism on holding apparatus 16 detects the tag on card 12 thus preventing a built-in alarm alerting the card owner. However, once card 12 is no longer detected within the predetermined range the card owner is alerted by either an audible signal or by other means such as a vibration of holding apparatus 16. Similarly, holding apparatus 16 could be used to detect any objects by simply incorporating the tag on the object, such as a suitcase, which would be particularly useful while traveling. Detection and alerting mechanisms are common and easy to incorporate in the present invention by those skilled in the art of electronic communication systems.

A further feature of the present invention, useable alone or in conjunction with other features and embodiment of the present invention is a method concerned with transaction security, specifically a method for determining if a transaction such as a credit card transaction is allowed.

A list of security codes is generated. Although the security code list may include only two security codes, most advantageously the security code list is long, including tens, hundred or even thousands of security codes. A holder of the present invention, as described hereinabove, is loaded with a first copy of the security code list. A second copy of the list of security codes is retained at the credit card company (or whatever location the confirmation procedure actually occurs).

In a less preferable embodiment, the security code list (and hence the two copies) is replenished or replaced at intervals. Replenishment or replacement of the first copy stored on the card can be performed using an ATM, a dedicated device, or using a communication means equipped holder of the present invention. The disadvantage of this less preferred embodiment is that the security code list is transmitted and thus susceptible to interception and misuse.

According to a preferred embodiment, the first copy of the security code list is stored in a holder of the present invention before the holder is given to the user of the respective card. The security code list is used for the lifetime of the holder. The security code list may be sufficiently long or may be configured to act as an endless loop. In this preferred embodiment, the list of security codes is never transmitted and stored at only two locations, the first copy on the holder of the present invention and the second copy at the credit card company.

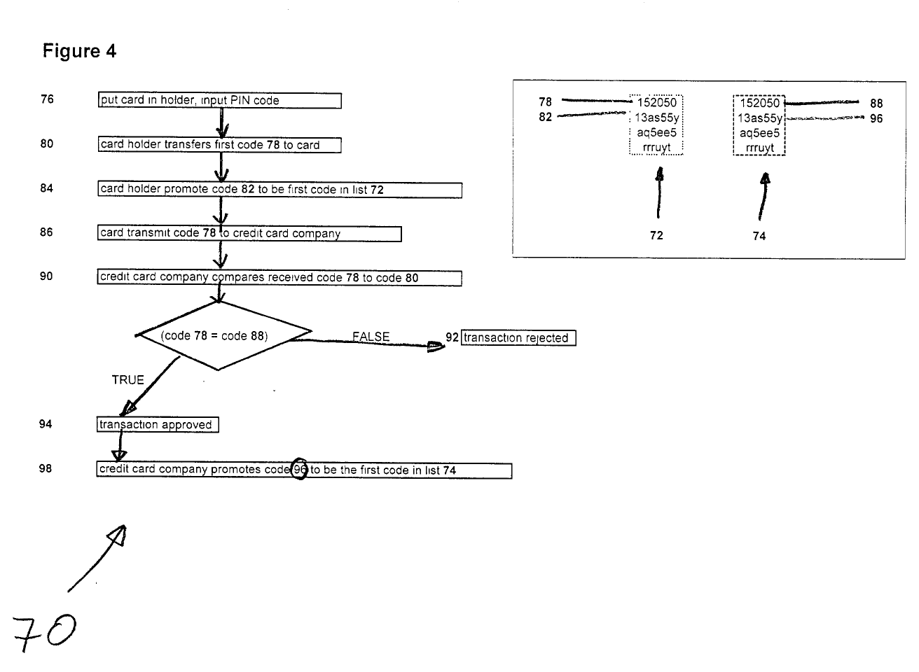

Use of a credit card protected using the method of the present invention is depicted by flow chart 70 in FIG. 4. The holder of the present invention stores a first copy 72 of a security code list whereas the credit card company stores a second copy 74 of the same security code list.

When it is desired to use a credit card, the credit card is put in a holder of the present invention and the PIN code or other appropriate code is input through the key board of the holder, box 76.

Input of the PIN code causes the holder to transfer the first security code 78 (152050) from holder security code list 72 to the credit card, box 80. As a result, the credit card is activated for use in performing a transaction.

Further, the holder promotes the following security code 82 (13as55y) from holder security code list 72 to be the new first security code, box 84.

When data is transmitted from the credit card to the credit card company for the purpose of performing a transaction or other function, also transmitted is security code 78, box 86.

The credit card company receives and compares the received holder security code 78 (152050) to the first security code 88 (152050) of credit card company security code list 74, box 90.

If security code 88 is not identical to the received holder security code 78 the transaction is not approved, box 92.

If security code 88 is identical to the received holder security code 78, the transaction is approved, box 94.

Approval of the transaction causes the credit card company to activate the following security code 96 (13as55y) from credit card security code list 74, box 98.

Needless to say, that a separate security code list is generated, stored and maintained for each holder. Thus the credit card company maintains a plurality of second copies of security code lists, one copy for each holder.

Although as described above the security code list stored by the holder and the security code list stored by the credit card company are identical, it is possible that the two lists not be identical and the relationship sought when comparing the holder security code and the credit card company security code not be equality but a different mathematical function. It is necessary that the confirming location know what relationship the two security codes need to have to allow a transaction to take place.

Although specifically described for the approval of financial transactions, it is clear to one skilled in the art that the method of the present invention is also useful for other transactions. For example, when a magnetic card is used to gain entry into a secured area, for example in a factory. Further, it is also possible to use the method of the present invention in conjunction with the holder of the present invention as described hereinabove to confirm that a card has not been stolen. If the credit card company suspects that the card is being misused, the company contacts the owner of the card. The owner is asked to use the holder of the present invention to transfer a security code to the company, substantially as described hereinabove, to confirm that indeed the card and holder have not been stolen.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. An information storage and retrieval system comprising:
a. at least one card for electromagnetic storage of information; and
b. a holding apparatus having:
i. an opening for insertion thereto and removal therefrom of a said at least one card;
ii. a mechanism for reversibly disabling said at least one card for storing information;
wherein said holding apparatus is functional as a mobile telephone.

2. The system of claim 1, wherein said at least one card is selected from the group consisting of credit cards, bank cards, gas cards, security key cards, medical and personal record cards, building access cards, room access cards, elevator access cards, security access cards, personnel cards, Automatic Teller Machine cards, debit cards, key substitute cards, telephone cards and cash cards.

3. The system of claim 2, wherein said at least one card is selected from the group consisting of magnetic cards, electronic smart cards and passive electronic cards.

4. The system of claim 3, wherein said at least one card is initially biased to be in a disabled mode.

5. The system of claim 4, wherein, when one of said at least one card is inserted in said opening, said holding apparatus holds at least part of said one card and is in at least partial contact with a portion of said one card where the information is stored.

6. The system of claim 5, wherein said mechanism for enabling said at least one card includes a keyboard.

7. The system of claim 6, wherein said mechanism for enabling said at least one card includes a mechanism for entering an identification code.

8. The system of claim 3, wherein said at least one card is operative to be enabled only via said holding apparatus.

9. The system of claim 1, wherein said holding apparatus is configured to retrieve the information from said at least one card and communicating the information to a remote location.

10. The system of claim 1, wherein said holding apparatus includes a mechanism for loading the information stored on said at least one card.

11. The system of claim 1, wherein said holding apparatus includes a mechanism for altering the information stored on said at least one card.

12. The system of claim 1, wherein said system further comprises:
d. a range detection mechanism including:
i. a tag operationally associated with said card;
ii. a mechanism for locating the tag within a predetermined range, operationally associated with said holding apparatus; and
iii. an alerting mechanism if said card is not detected within said predetermined range.

13. A method of determining if a transaction is allowed comprising:
a. providing a first ordered security code list stored in a first device;
b. providing a second ordered security code list stored in a second device;
c. copying a first specific security code from said first ordered security code list to a third device;
d. transferring said first specific security code to a confirmation location;
e. transferring a second specific security code from said second ordered security code list to said confirmation location;
f. comparing said first specific security code and said second specific security code for a predetermined relationship;
g. if, subsequent to f, said predetermined relationship exists the transaction is allowed; and
h. if, subsequent to f, said predetermined relationship does not exist the transaction is not allowed.

15. The method of claim 13 wherein said predetermined relationship is equality.

16. The method of claim 13 wherein said first and said second list are substantially identical.

17. The method of claim 13 wherein said third device is selected from a group consisting of credit cards, bank cards, gas cards, security key cards, medical and personal record cards, building access cards, room access cards, elevator access cards, security access cards, personnel cards, Automatic Teller Machine cards, debit cards, key substitute cards, telephone cards and cash cards.

18. The method of claim 13 wherein said copying of said first specific security code from said first ordered security code list to said third device is contingent on entering an identification code on a keyboard of said first device.

19. The method of claim 13 wherein said first device is functional as a mobile telephone.

20. A method for payment of a purchase by a purchaser to a vendor using a credit card, the method comprising:
(a) establishing by the purchaser an account with a credit entity company;
(b) storing information by the credit entity company about said account on the credit card;
(c) providing by the purchaser a holding apparatus for the credit card capable of communicating with said credit entity company; and
(d) debiting purchaser's account by said credit entity company said at least one account for the purchase.

21. The method of claim 20 further comprising:
(e) informing the vendor of said debiting of said account, by said at least one credit entity company; and
(f) provision of the purchase by the vendor to the purchaser.
